(19) United States
(12) Patent Application Publication
(10) Pub. No.: US 2010/0246355 A1
(43) Pub. Date: Sep. 30, 2010

(54) INFORMATION PROCESSING APPARATUS, INFORMATION PROCESSING METHOD, AND PROGRAM

(75) Inventors: Kenjiro Ueda, Kanagawa (JP); Shoei Kobayashi, Kanagawa (JP); Katsumi Muramatsu, Tokyo (JP); Kousuke Misono, Kanagawa (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: SONY CORPORATION, Tokyo (JP)

(21) Appl. No.: 12/713,762

(22) Filed: Feb. 26, 2010

(30) Foreign Application Priority Data
Mar. 27, 2009 (JP) 2009-078663

(51) Int. Cl. G11B 19/04

(52) U.S. Cl. 369/53.21; G9B/19.005

(57) ABSTRACT

An information processing apparatus includes a data processing unit configured to perform data processing on data read from a data recordable disc. The data processing unit performs a physical mark verification process for verifying whether or not a physical mark that is identification data unique to each of mother discs used when the disc was manufactured has been recorded on the disc, and a signature verification process for obtaining, from the disc, a token containing an electronic signature generated on the basis of a medium ID that is an identifier unique to each disc by a content providing server that provided the recorded content of the disc and for performing signature verification, and reproduces recorded content of the disc under a condition in which the recording of a physical mark in the physical mark verification process has been confirmed and signature verification in the signature verification process holds true.

### BACKGROUND OF THE INVENTION

1. Field of the Invention

The present invention relates to an information processing apparatus, an information processing method, and a program. More particularly, the present invention relates to an information processing apparatus, an information processing method, and a program that realize use control of content.

2. Description of the Related Art

As data recording media (information recording media), in recent years, Blu-ray Discs (registered trademark), digital versatile discs (DVDs), and the like have been widely used. These media are used to record and reproduce various content, such as movies and music.

Examples of types of media include read-only media, such as DVD-ROM media and BD-ROM media, on which data has been pre-recorded and writing of new data is not permitted, and rewritable media, such as DVD-RAM/R/RW media, DVD+RW/+R-media, and BD-R/RE media, on which data writing by a user is possible.

Read-only media are recorded with various content, such as, for example, movies and music at a disc factory, and are provided to a user. Also, rewritable media, after being purchased by a user, are installed into a user device, such as a PC or a recorder, and content downloaded via a network and broadcast content can be recorded thereon. Alternatively, by using a terminal disposed at a public place, content selected by a user can be recorded and used.

As a content providing form using rewritable media, for example, Electric Sell Through (EST) and Manufacturing on Demand (MoD) are available. EST is a content providing service in which, by using a user device, such as a recorder or a PC, which is capable of writing data on a medium, content downloaded from a content providing server, and the like is recorded. MoD is a content providing service in which, by using a shared terminal located in, for example, a convenience store or a public space, content received from a server is recorded on a medium. These content providing services are disclosed in, for example, Japanese Unexamined Patent Application Publication No. 2008-159233, Japanese Unexamined Patent Application Publication No. 2008-98765, and the like.

The copyright and the distribution rights of much of the content obtained via a broadcast and via a network in addition to content recorded in advance on media are owned by a content creator or a seller. Therefore, for much of the content to be provided to the user, use control and management for preventing illegal copying are necessary. More specifically, encoding of content, use management and use control based on content and identification data of media, etc., are performed. For example, a control configuration is adopted in which use of content reproduction, and the like is permitted for only an authorized user so that non-permitted copying or the like is not performed. Furthermore, management in which if pirated discs produced by illegal copying are distributed on the market, the copy source thereof can be tracked is performed.

For example, on media, a medium ID (serial number) that differs for each of the media at the manufacturing stage is written. For example, on recordable discs, a medium ID is recorded in a burst cutting area (BCA), which is a special data recording area differing from that of general data. The BCA area is an area differing from an ordinary data recording area, and data is recorded by a physical cutting process differing from an ordinary data recording method. Therefore, it is difficult to rewrite recording data in the BCA area, and a special reading process differing from an ordinary data reproduction process becomes necessary during a reproduction process. For example, in a case where illegally copied pirated versions are distributed on the market, if a medium ID (serial number) is identified, the copy source thereof can be tracked.

Since the correspondence between the medium ID and the recorded content of ROM media is fixed, it is possible to identify the disc factory, which is the recording source of the content, and the medium manufacturing source that is the copy source thereof can be tracked.

However, in the case of R/RE-type media, content can be recorded on media as desired by a user, and the correspondence between a medium ID (serial number) that is the identifier of the medium and the content is not fixed. Therefore, when pirated versions of certain content are distributed on the market, it is difficult to track the copy source thereof. Thus, there has been a demand for more strictly preventing illegal content use. The method of writing a serial number to a BCA area has been disclosed. An unauthorized person having certain knowledge, such as someone producing a pirated disc, might apply the disclosed data writing method so as to write an illegal medium ID (serial number).

### SUMMARY OF THE INVENTION

It is desirable to provide an information processing apparatus, an information processing method, and a program that are capable of preventing unauthorized use of disc recorded content and realizing stringent use control of content in a configuration in which a user records desired content on a data writable medium, such as an R/RE-type medium and uses it.

According to an embodiment of the present invention, there is provided an information processing apparatus including: a data processing unit configured to perform data processing on data read from a data recordable disc, wherein the data processing unit performs a physical mark verification process for verifying whether or not a physical mark that is identification data unique to each of mother discs used when the data recordable disc was manufactured has been recorded on the data recordable disc, and a signature verification process for obtaining, from the data recordable disc, a token containing an electronic signature generated on the basis of a medium ID that is an identifier unique to each data recordable disc by a content providing server that provided the recorded content of the data recordable disc and for performing signature verification, and the data processing unit reproduces recorded content of the data recordable disc under a condition in which the recording of a physical mark in the physical mark verification process is confirmed and the signature verification in the signature verification process holds true.

The physical mark and the medium ID may be data recorded on the data recordable disc at a disc factory. The token may be a token that contains the electronic signature generated on the basis of the medium ID by the content providing server that provided the content when performing a content recording process on the data recordable disc.

According to another embodiment of the present invention, there is provided an information process system including: a drive configured to perform data reading from a data recordable disc; and an information processing apparatus including a data processing unit that obtains data read from the data recordable disc via the drive and that performs data processing, wherein the drive performs a physical mark verification process for verifying whether or not a physical mark that is identification data unique to each of mother discs used when the data recordable disc was manufactured has been recorded on the data recordable disc, and outputs the recorded data of the data recordable disc to the information processing apparatus under a condition in which the recording of the physical mark has been confirmed in the physical mark verification process, and wherein the data processing unit performs a signature verification process for obtaining, from the data recordable disc, a token containing an electronic signature generated on the basis of the medium ID that is an identifier unique to each data recordable disc by a content providing server that provided the recorded content of the data recordable disc, and for performing signature verification, and reproduces the recorded content of the data recordable disc under a condition in which the signature verification in the signature verification process holds true.

The physical mark and the medium ID may be data recorded on a data recordable disc at a disc factory. The token may be a token that contains the electronic signature generated on the basis of the medium ID by the content providing server that provided the content when performing a content recording process on the data recordable disc.

According to another embodiment of the present invention, there is provided an information processing apparatus including: a data processing unit configured to perform data processing on data read from a data recordable disc, wherein the data processing unit obtains, from the data recordable disc, a token containing an electronic signature generated by a content providing server that provided the recorded content of the data recordable disc, and performs a signature verification process, and reproduces the recorded content of the data recordable disc under a condition in which the signature verification in the signature verification process holds true, and wherein the token is a token containing an electronic signature generated on the basis of a computation operation result of a physical mark that is identification data unique to each of mother discs used when the data recordable disc was manufactured, and a medium ID that is an identifier unique to each data recordable disc, the physical mark and the medium ID being recorded on the data recordable disc.

The token may be a token containing an electronic signature generated on the basis of an exclusive OR operation result of the physical mark and the medium ID. The data processing unit may perform an exclusive OR operation of the physical mark and the medium ID that are recorded on the data recordable disc, and may perform a comparison process with the exclusive OR operation result when performing a process for verifying the signature contained in the token.

The physical mark and the medium ID may be data recorded on a data recordable disc at a disc factory. The token may be a token that contains the electronic signature generated on the basis of the medium ID by the content providing server that provided the content when performing a content recording process on the data recordable disc.

According to another embodiment of the present invention, there is provided an information processing apparatus including: a data processing unit configured to perform data processing on data read from a data recordable disc, wherein the data processing unit obtains, from the data recordable disc, a physical mark that is identification data unique to each of mother discs used when the data recordable disc was manufactured, and a medium ID that is an identifier unique to each data recordable disc, and transmits the physical mark and the medium ID to a content providing server, and receives, from the content providing server, a token containing an electronic signature generated on the basis of the computation operation result of the physical mark and the medium ID, and content, and records the token and the content on the data recordable disc.

The token is a token containing an electronic signature generated on the basis of the exclusive OR operation result of the physical mark and the medium ID.

The physical mark and the medium ID may be data recorded on a data recordable disc at a disc factory. The token may be a token that contains the electronic signature generated on the basis of the medium ID by the content providing server that provided the content when performing a content recording process on the data recordable disc.

According to another embodiment of the present invention, there is provided an information processing method for performing data processing on data read from a data recordable disc in an information processing apparatus, the information processing method including the steps of: verifying, by using a data processing unit, whether or not a physical mark that is identification data unique to each of mother discs used when the data recordable disc was manufactured has been recorded on the data recordable disc; obtaining, by using a data processing unit, from the data recordable disc, a token containing an electronic signature generated on the basis of a medium ID that is an identifier unique to each data recordable disc by a content providing server that provided the recorded content of the data recordable disc, and performing signature verification; and reproducing, by using a data processing unit, recorded content of the data recordable disc under a condition in which the recording of the physical mark in the physical mark verification process has been confirmed and the signature verification in the signature verification process holds true.

According to another embodiment of the present invention, there is provided an information processing method for performing data processing on data read from a data recordable disc in an information processing apparatus, the information processing method including the steps of: performing, by using a data processing unit, a computation process of a physical mark that is identification data unique to each of mother discs used when the data recordable disc was manufactured, and a medium ID that is an identifier unique to each data recordable disc; obtaining, by using a data processing unit, from the data recordable disc, a token containing an electronic signature generated by a content providing server that provided the recorded content of the data recordable disc, and performing a signature verification process including a process for comparing data generated on the basis of the electronic signature with the resulting data of the computation operation process; and reproducing recorded content of the data recordable disc under a condition in which the signature verification in the signature verification process holds true.

According to another embodiment of the present invention, there is provided an information processing method for performing data processing on data read from a data recordable disc in an information processing apparatus, the information processing method including the steps of: obtaining, by using a data processing unit, from the data recordable disc, a physical mark that is identification data unique to each of mother discs used when the data recordable disc was manufactured, and a medium ID that is an identifier unique to each data recordable disc, and transmitting the physical mark and the medium ID to a content providing server; and receiving, by using the data processing unit, from the content providing server, a token containing an electronic signature generated on the basis of the computation operation result of the physical mark and the medium ID, and content, and recording the medium ID and the content on the data recordable disc.

According to another embodiment of the present invention, there is provided a non-transitory recording medium including a program for processing data read from a recordable medium, the program including the steps of: causing a data processing unit to verify whether or not a physical mark that is identification data unique to each of mother discs used when a data recordable disc was manufactured has been recorded on the data recordable disc; causing the data processing unit to obtain, from the data recordable disc, a token containing an electronic signature generated on the basis of a medium ID that is an identifier unique to each data recordable disc by a content providing server that provided the recorded content of the data recordable disc, and to perform signature verification; and causing the data processing unit to reproduce recorded content of the data recordable disc under a condition in which the recording of the physical mark in the physical mark verification process has been confirmed and the signature verification in the signature verification process holds true.

According to another embodiment of the present invention, there is provided a non-transitory recording medium including a program for processing data read from a recordable medium, the program including the steps of: causing a data processing unit to perform a computation process of a physical mark that is identification data unique to each of mother discs used when a data recordable disc was manufactured, and a medium ID that is an identifier unique to each data recordable disc; causing the data processing unit to obtain, from the data recordable disc, a token containing an electronic signature generated by a content providing server that provided the recorded content of the data recordable disc, and to perform a signature verification process including a process for comparing data generated on the basis of the electronic signature with the resulting data of the computation operation process; and reproducing recorded content of the data recordable disc under a condition in which the signature verification in the signature verification process holds true.

According to another embodiment of the present invention, there is provided a non-transitory recording medium including a program for processing data read from a recordable medium, the program including the steps of: causing a data processing unit to obtain, from the data recordable disc, a physical mark that is identification data unique to each of mother discs used when a data recordable disc was manufactured, and a medium ID that is an identifier unique to each data recordable disc, and transmitting the physical mark and the medium ID to a content providing server; and causing the data processing unit to receive, from the content providing server, a token containing an electronic signature generated on the basis of the computation operation result of the physical mark and the medium ID, and content, and to record the medium ID and the content on the data recordable disc.

A program according to an embodiment of the present invention is, for example, a program that can be provided in a computer readable format using a storage medium or a communication medium to an information processing apparatus or a computer system capable of executing various codes. By providing such a program in a computer readable format, processing corresponding to the program is implemented on the computer system.

Further objects, features and advantages of the present invention will become apparent from a more detailed description of embodiments to be described later with reference to the attached drawings. In this specification, the system designates a logical assembly of a plurality of devices, and it does not matter whether the devices are disposed in the same housing.

According to an embodiment of the present invention, a physical mark that is identification information corresponding to a disc at a manufacturing stage and a medium ID that is identification information unique to a disc are recorded on the disc that can be recorded by a user. When performing a content recording process, a medium ID, or a medium ID and a physical mark are transmitted to a content providing server, and a token including signature data is received and recorded together with the content on the disc. When performing reproducing content, verification of a token signature, and confirmation of the recording of a physical mark are performed, and the content is reproduced under the condition of these confirmations. With this configuration, stringent content use control based on the authenticity confirmation of the disc and the content distribution server is realized.

### BRIEF DESCRIPTION OF THE DRAWINGS

FIG. 1 illustrates examples of the structures of a disc and stored data;

FIG. 2 illustrates identification data recorded on a disc;

FIG. 3 illustrates examples of a data recording process and a data reproduction process using a disc according to an embodiment of the present invention;

FIG. 4 illustrates examples of a data recording process and a data reproduction process using a disc according to an embodiment of the present invention;

FIG. 5 illustrates examples of a data recording process and a data reproduction process using a disc according to an embodiment of the present invention;

FIG. 6 illustrates examples of a data recording process and a data reproduction process using a disc according to an embodiment of the present invention;

FIG. 7 illustrates an example of a physical mark;

FIG. 8 illustrates an example of the configuration of an information processing apparatus according to an embodiment of the present invention; and

FIG. 9 illustrates an example of the configuration of an information processing apparatus according to an embodiment of the present invention.

### DESCRIPTION OF THE PREFERRED EMBODIMENTS

With reference to the drawings, an information processing apparatus, an information processing method, and a program according to embodiments of the present invention will be described below in detail. The descriptions will be given in the following order.

1. Example of structure of medium
2. Data recording and reproduction processing example 1 (first embodiment)
3. Data recording and reproduction processing example 2 (second embodiment)
4. Data recording and reproduction processing example 3 (third embodiment)
5. Data recording and reproduction processing example 4 (fourth embodiment)
6. Specific example of physical mark
7. Example of configuration of information processing apparatus

### 1. Example of Structure of Medium

First, an example of the structure of a medium used in an embodiment of the present invention will be described. Media that can be used in the processing according to an embodiment of the present invention are media on which a user can record any desired data. Examples thereof include discs on which data can be written by a user, such as DVD-RAM/R/RW discs, DVD+RW/+R discs, and BD-R/RE discs.

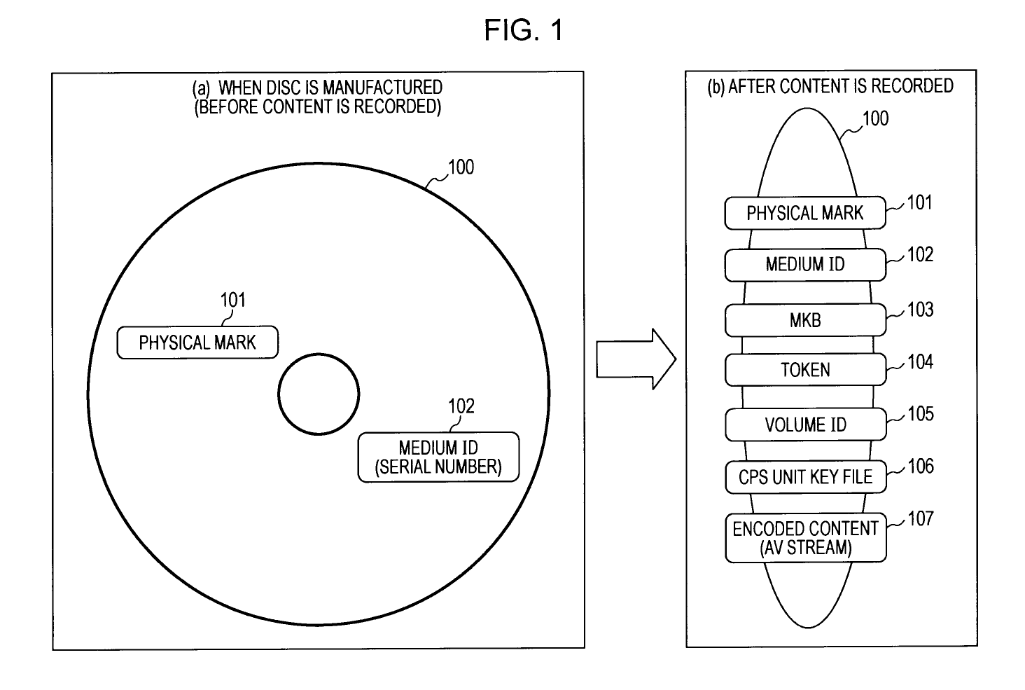

FIG. 1 shows (a) a disc 100 when the disc is manufactured (before content is recorded), and (b) the disc 100 after content is recorded.

(a) The disc 100 when the disc is manufactured (before content is recorded) is a disc manufactured at a disc factory (disc manufacturer). This disc 100 is provided to the user, and the user can record thereon any desired content, for example, content of a movie.

On the disc 100 at the time of disc manufacture (before content is recorded), a physical mark 101 and a medium ID (serial number) 102 are recorded. These are identification information recorded on each disc when the disc is manufactured at the disc factory. More specifically, the physical mark is identification data unique to each mother disc used when the disc is manufactured.

Discs on which these items of identification information are recorded are provided to the user via a sale shop and the like. It is possible for the user to record data containing content of a movie or the like on the disc 100. In this example, it is assumed that content to be recorded on the disc 100 is content subjected to use control and is encoded content 107 as shown in FIG. 1.

The encoded content 107 is provided, for example, from a content distribution server to a reproduction apparatus of a user. Not only the encoded content 107, but also various data is provided to the reproduction apparatus of the user from the content distribution server, and the various data is recorded together with the content. More specifically, the various data is data, such as data used to perform a content decoding process in the reproduction apparatus, or data used to determines whether or not the reproduction apparatus is an apparatus in which the use of content is permitted.

The data of a media key block (MKB) 103, a token 104, a volume ID 105, a CPS unit key file 106, and encoded content 107 shown in the disc 100 of part (b) of FIG. 1 is provided from the content distribution server to the reproduction apparatus of the user, and is recorded therein. The data and the recording sequence will be described later in detail.

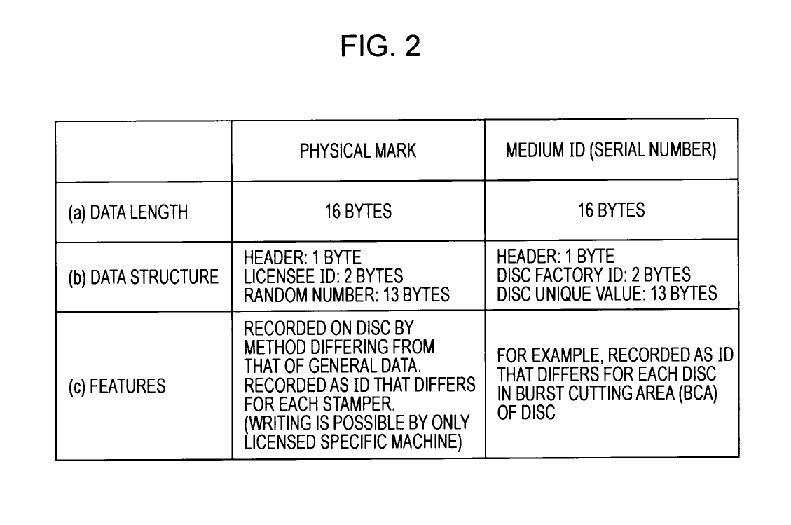

A description will be given below, with reference to FIG. 2, of a physical mark 101 recorded on the disc 100 shown in part (a) of FIG. 1 before the content is recorded, and the medium ID (serial number) 102.

FIG. 2 shows (a) data length, (b) data structure, and (c) features of each of the physical mark and the medium ID (serial number).

The physical mark has a data length of 16 bytes, and is formed of a header=1 byte, a licensee ID=2 bytes, and a random number=13 bytes.

The header is identifier data indicating that the associated data is a physical mark. For example, the header=[0x01] is defined. In a case where a process for decoding and reproducing content recorded on a disc is to be performed, the reproduction apparatus or the drive verifies whether or not a physical mark has been recorded on the disc, and performs decoding and reproduction of the content under the condition that a physical mark has been recorded on the disc. The reproduction apparatus or the drive reads the physical mark from the physical mark recording position in accordance with a predetermined reading sequence, and confirms whether or not the beginning 1 byte that is a header portion is [0x01]. In a case where the beginning 1 byte is [0x01], the disc is determined to be a disc on which the physical mark has been recorded. The specific processing sequence will be described later.

The licensee ID is identification information regarding a disc factory at which the recording of the physical mark has been permitted, or is identification information of a physical mark recording device. A random number is formed using information calculated by a random number generation method in which a preset criterion is satisfied.

The physical mark has the following features:

Data recorded on the disc by a method differing from that of general data,

Data recorded as an ID that is different for each stamper, and

Data that can be written only by a specific licensed device [physical mark recording device].

As described above, the physical mark is recorded by a recording method differing from that of the recording form of general data, that is, encoded content or the like. The physical mark can be written by only a specific licensed apparatus [physical mark recording apparatus]. The license is a license that is given to a disc factory or the like by a management center that performs use management of content. A physical mark recording device that is applied to the recording of the physical mark is provided to a licensed disc factory. The physical mark recording device is used to record a physical mark that is identification information in a stamper unit.

The physical mark is an identifier (ID) that is set in a stamper unit, with the same physical mark being recorded on a disc manufactured from the same stamper.

Next, the medium ID (serial number) will be described. The medium ID (serial number) has a data length of 16 bytes, and is formed by a header=1 byte, a disc factory (Disc manufacturer) ID=2 bytes, and a unique value=13 bytes.

The header is identifier data indicating that the associated data is a medium ID (serial number). The disc factory (disc manufacturer) ID is an identifier (ID) that is set regarding the disc manufacturing factory. The unique value is a value different for each disc, for example, a serial number.

The medium ID (serial number) is data recorded as an ID different for each disc in a burst cutting area (BCA). As described above, the BCA area is an area in which data is recorded by a physical cutting process differing from a typical data recording method. Therefore, the recording data of the BCA area is difficult to be rewritten, and a special reading process differing from a typical data reproduction process becomes necessary for the reproduction process.

The byte length and the data structure of each item of data, shown in FIG. 2, are examples, and the data length can be set to be different from the data length shown in FIG. 2. Furthermore, regarding the data structure, the data length of each item of data may be set to be different and may further be set to include other constituent data.

### 2. Data Recording and Reproduction Processing Example 1

### First Embodiment

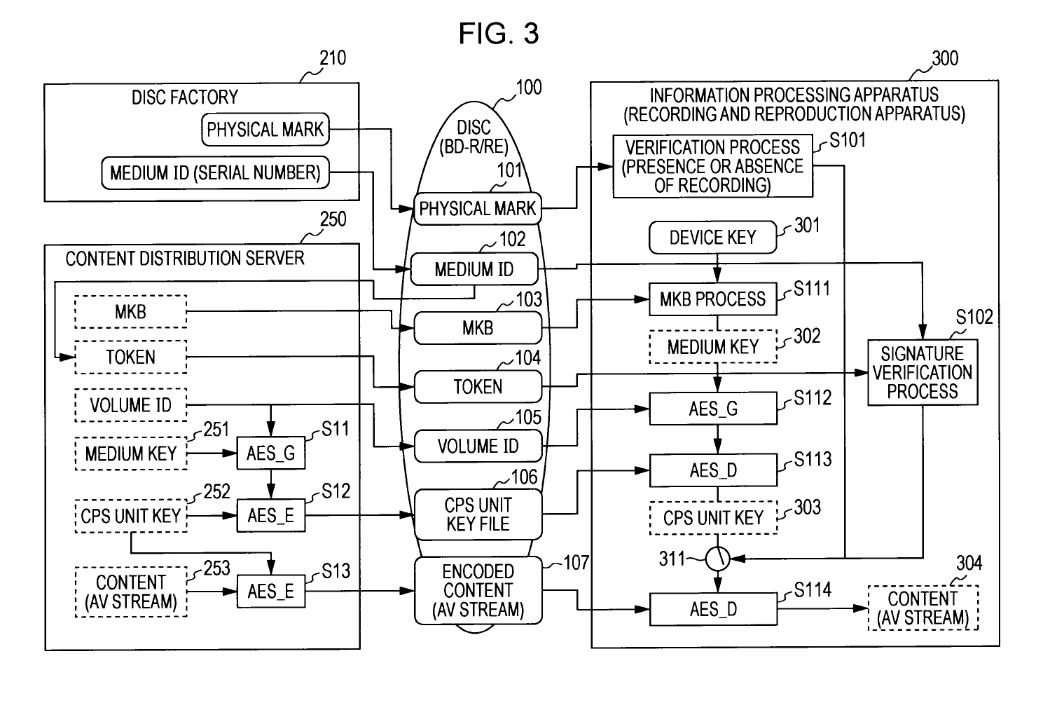

Next, a description will be given, with reference to FIG. 3, of a first embodiment of a process for recording content on a disc, and a process for reproducing content from a disc.

FIG. 3 shows the disc factory 210 for manufacturing a disc 100, a content providing server 250 for providing recorded data containing content to be recorded on the disc 100, and an information processing apparatus (recording and reproduction apparatus) 300 for performing a content recording process on the disc 100 and a process for reading data recorded on the disc 100 so as to reproduce content.

As described earlier, the disc factory 210 performs a process for the physical mark 101 and the medium ID (serial number) 102 on the disc 100. The user purchases the disc 100 on which the physical mark 101 and the medium ID (serial number) 102 have been recorded.

The user loads the disc 100 into the information processing apparatus 300, and performs communication with the content providing server 250 that provides content, and records the content selected by the user. The content providing server 250 and the information processing apparatus 300 perform communication via a network. Recording data for the disc 100 is provided from the content providing server 250 to the information processing apparatus 300, and the information processing apparatus 300 performs data recording on the disc 100.

When performing the content recording process, the content providing server 250 provides the data of the MKB 103, the token 104, the volume ID 105, the CPS unit key file 106, and the encoded content 107. The information processing apparatus 300 records the data received from the content providing server 250 on the disc 100.

The MKB 103 is a key block in which a medium key that is necessary to generate a key applied to a process for decoding the encoded content 107 is stored as encrypted data. The medium key has a structure that can be extracted by an MKB process using a device key stored in the information processing apparatus 300. However, the MKB is provided in such a manner that an updating process is performed as appropriate and is updated to the setting with which it is difficult to obtain a medium key by a device key stored in the deactivated information processing apparatus.

The token 104 is generated by the content providing server 250. The token 104 is data that is generated in such a manner that when the information processing apparatus 300 records content on the disc 100, the medium ID 102 recorded on the disc 100 is transmitted to the content providing server 250, and a signature process is performed by the content providing server 250.

The token 104 contains, as constituent data, the server information of the content providing server 250 that performs, for example, a content providing process, such as server information formed from the public key and the server identifier (ID) of the server, the medium ID recorded on the disc 100, and the like. Furthermore, the token 104 is data in which an electronic signature for the data including at least the constituent data of the medium ID is attached. The signature is generated by applying, for example, a secret key of the content providing server.

The information processing apparatus 300 performs a process for verifying the signature of the token 104 before the encoded content 107 recorded on the disc 100 is decoded and reproduced. The information processing apparatus 300 performs the verification of the signature set in the token 104 by using the public key of the content providing server 250, and performs an authenticity confirmation process for the token 104. With this process, the configuration is formed in such a way that, after the supply source of the encoded content 107 is confirmed to be a legitimate apparatus, the decoding of the content is permitted. The details of the reproduction processing sequence will be described later.

The volume ID 105 is identification information (ID) that is set in such a manner as to correspond to a set of content provided by the content providing server 250, such as, for example, a set of content of certain titles, or a set of provided content in a certain period. The volume ID 105 is generated by the content providing server 250 and is recorded on the disc 100.

The content providing server 250 further performs a key generation process (AES_G) using the volume ID and the medium key stored in the MKB in step S11 shown in FIG. 3. Furthermore, in step S12, the content providing server 250 performs an encryption process (AES_E) of the CPS unit key 252 that is the encryption key of the content by using the generated key so as to generate a CPS unit key file 106. This CPS unit key file 106 is recorded on the disc 100.

Furthermore, in step S13, the content providing server 250 performs an encryption process (AES_E) of content 253 in which the CPS unit key 252 is applied so as to generate encoded content 107. This encoded content 107 is recorded on the disc 100.

Next, a description will be given of the processing of the information processing apparatus 300 that performs a process for decoding and reproducing the encoded content 107 recorded on the disc 100. The processing of steps S101 to S114 shown inside the information processing apparatus 300 of FIG. 3 is performed by the data processing unit of the information processing apparatus 300. The information processing apparatus 300 is configured to include a memory having stored therein programs to be executed by the data processing unit, and the data processing unit is configured to include, for example, a CPU that performs data processing in accordance with a program read from the memory.

The information processing apparatus 300 has a device key 301 in the memory. The device key 301 is key data used to be applied to obtain a medium key from the MKB 103.

First, in step S101, the information processing apparatus 300 performs a process for verifying whether or not the physical mark 101 has been recorded on the disc 100. As described earlier, this verification process is performed, for example, as a determination process in which the header information of the beginning 1 byte of the physical mark 101 is read so as to determine whether or not the header information has information indicating a physical mark.

In a case where the physical mark 101 has not been recorded on the disc 100, the subsequent processing is not performed. That is, the use (reproduction) process of the content is cancelled.

If it is confirmed in step S101 that the physical mark 101 has been recorded on the disc 100, the process proceeds to step S102. In step S102, the information processing apparatus 300 reads the medium ID 102 and the token 104 that are recorded on the disc 100, and performs a signature verification process. As described earlier, the token 104 is data containing a signature for the data containing the medium ID 102 recorded on the disc 100. The token 104 is a signature generated by the content providing server 250.

In step S102, the information processing apparatus 300 performs signature verification by applying the public key of the content providing server 250. Data processing using the public key of the content providing server 250 is performed on the signature contained in the token 104. The processing result is compared with the constituent data of the medium ID 102 recorded on the disc 100. When they match, it is determined that the signature verification holds true. As a result of the signature verification holding true, the authenticity of the token 104 is confirmed. This corresponds to a process for confirming that the supply source of the encoded content 107, that is, the content providing server 250, is a legal apparatus. After this confirmation is made, the decoding of the content is permitted.

In a case where the signature verification does not hold true, the token 104 is determined to be illegal, and the content providing server 250 determines that the content providing server 250 is not a legal apparatus. In this case, the subsequent processing is cancelled. That is, the content use (reproduction) process is cancelled.

Only when it is confirmed in step S101 that the physical mark 101 has been recorded on the disc 100 and it is confirmed in step S102 that the signature verification process holds true, the process proceeds to the next process, that is, a decoding and reproduction sequence (S111 to S114) for the encoded content 107 recorded on the disc 100.

The reproduction sequence will be described. Initially, in step S111, an MKB process is performed on the MKB 103 read from the disc 100 by using the device key 301 stored in the memory of the information processing apparatus 300, thereby extracting a medium key 302 from the MKB 103.

Next, in step S112, a key generation process (AES_G) using the volume key 105 read from the disc 100 and the medium key 302 obtained from the MKB is performed to generate a key applied to the decoding of the CPS unit key file 106 stored on the disc 100.

Next, in step S113, by using the generated key, a process for decoding the CPS unit key file 106 read from the disc 100 (AES_D) is performed to obtain a CPS unit key 303.

Next, in step S114, by using the obtained CPS unit key 303, a process for decoding the encoded content 107 read from the disc 100 (AES_D) is performed to obtain and reproduce content 304.

A switch 311 shown in the figure is shown to illustrate that only when it is confirmed in the process of step S101 that the physical mark 101 has been recorded on the disc 100 and when the authenticity of the token 104 has been confirmed in the signature verification process of step S102, the content can be decoded and reproduced. That is, it is not necessary for a physical switch to exist in the information processing apparatus 300, and the switch is a switch that conceptually shows that the continuation of the processing sequence is permitted or stopped.

In FIG. 3, the position of the switch 311, that is, the stop position of the processing, is shown before step S114. However, for example, the position of the switch 311 may be any position of the decoding or reproduction sequence, such as before the MKB process of step S111.

That is, it is necessary that the processing of steps S101 and S102 is performed before the processing of all the steps S111 to S114 is completed, the physical mark 101 has been recorded on the disc 100, and the authenticity of the token recorded on the disc 100 is confirmed.

As described above, in the present embodiment, the use permission conditions of encoded content recorded on the disc 100 are set as follows:

(1) Confirmation that the physical mark 101 has been recorded on the disc 100, and
(2) Confirmation of the authenticity of the token 104 (signature for the medium ID 102) recorded on the disc 100.

These two confirmations are conditions for permitting the use of the encoded content recorded on the disc 100. If either of the conditions is not satisfied, the use of the content is not permitted.

With the confirmation that the physical mark 101 has been recorded on the disc 100, it is confirmed that the disc 100 is a disc that has been produced at a legal factory. That is, it is confirmed that the disc 100 is a disc having a physical mark recorded by using a licensed physical mark recording device. Furthermore, with the signature verification of the token 104 (signature for the medium ID 102) recorded on the disc 100, the authenticity of the content providing server is confirmed.

The token 104 contains signature data for the medium ID 102, and the medium ID 102 is recorded at the disc factory that is a manufacturing entity of the disc. Therefore, the correspondence between the disc factory that is the manufacturing entity of the disc on which the medium ID has been recorded and the content distribution server that is the providing main body of the content, which has provided the disc on which the medium ID is recorded and the token containing the signature for the data containing the medium ID is linked by a token, making the correspondence clear.

As described above, it is set in the present embodiment that the use of the encoded content 107 recorded on the disc 100 is permitted under the condition that it is confirmed that the physical mark 101 has been recorded on the disc 100 and the signature verification of the token 104 (signature for the medium ID 102) recorded on the disc 100 holds true.

As a result of confirming that the physical mark 101 has been recorded on the disc 100, the disc authenticity is confirmed, which proves that the disc 100 has been produced at a legal factory. Furthermore, as a result of the signature verification of the token 104, the confirmation that the content provided by the legal content distribution server has been recorded on the disc is made. The fact that the authenticities of the content providing source and the disc supply source have been confirmed in the manner described above is used as the permission condition for content use. Such a content use control configuration makes it possible to prevent the use of an illegal disc or the use of the provided content of an illegal content providing server. Thus, it becomes possible to realize stringent content use control.

### 3. Data Recording and Reproduction Processing Example 2

### Second Embodiment

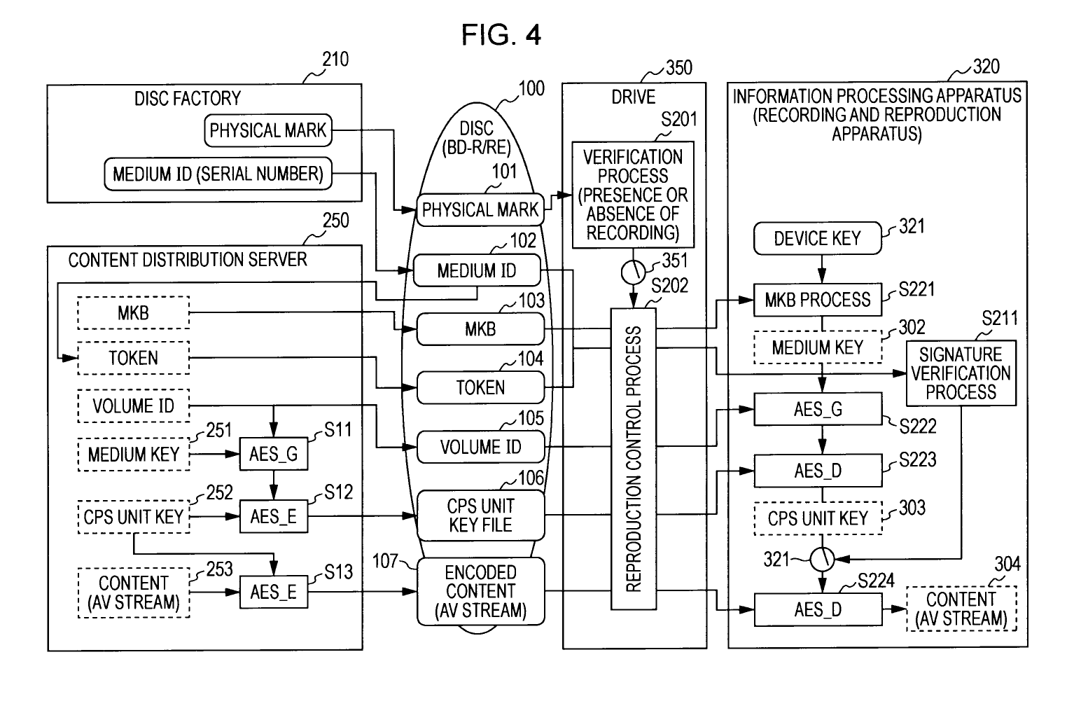

Next, a description will be given, with reference to FIG. 4, of a second embodiment of a process for recording content on a disc and a process for reproducing content from a disc according to the present invention.

FIG. 4 shows a disc factory 210 that manufactures a disc 100, the content providing server 250 that provides data containing content to be recorded on the disc 100, a drive 350 that performs a process for recording content on the disc 100 and that reads data from the disc 100, and an information processing apparatus (recording reproduction apparatus) 320 that performs recording and reproduction of data by using the disc 100 via the drive 350.

The first embodiment described with reference to FIG. 3 is configured in such a manner that the drive is included in the information processing apparatus 300. However, the second embodiment shown in FIG. 4 is configured in such a manner that the drive 350 and the information processing apparatus 320 are separate devices.

The disc factory 210 performs a process for recording the physical mark 101 and the medium ID (serial number) 102 on the disc 100. The user purchases the disc 100 on which the physical mark 101 and the medium ID (serial number) 102 have been recorded.

The user loads the disc 100 into the drive 350. The information processing apparatus 320 performs communication with the content providing server 250 that provides content, and records the content selected by the user.

The data recording process on the disc 100 is approximately the same as the processing described earlier with reference to FIG. 3. When performing the content recording process, the content providing server 250 provides the data of the MKB 103, the token 104, the volume ID 105, the CPS unit key file 106, and the encoded content 107 to the information processing apparatus 320. The information processing apparatus 320 records, on the disc 100, these items of data received from the content providing server 250 via the drive 350.

The decoding process and the reproduction process of the encoded content 107 recorded on the disc 100 will be described. In the present embodiment, the decoding process and the reproduction process are performed as the processing of both the drive 350 and the information processing apparatus 320.

The information processing apparatus 320 has a device key 321 in the memory. The device key 321 is key data used to obtain a medium key from the MKB 103.

Initially, in step S201, the drive 350 performs a verification process of whether or not the physical mark 101 has been recorded on the disc 100. As described earlier, this verification process is performed as a process in which, for example, the header information of the beginning 1 byte of the physical mark 101 is read, and it is determined whether or not the header information has data indicating a physical mark.

In a case where the physical mark 101 has not been recorded on the disc 100, the subsequent processing is not performed. That is, the switch 351 shown in the figure is set off, and the processing in and subsequent to step S202 is not performed. Similarly to the first embodiment described above, the switch 351 is shown for illustration, and it is not necessary for a physical switch to exist. That is, the switch is a switch for schematically showing that the continuation of the processing is permitted or stopped.

The reproduction control process of step S202, shown in the drive 350 of FIG. 4, is a process in which the MKB 103 . . . the encoded content 107 recorded on the disc 100 are provided to the information processing apparatus 320 via the drive 350. When the drive 350 determines in step S201 that the physical mark 101 has not been recorded on the disc 100, the process of step S202 is not performed, and the data recorded on the disc 100 is not provided to the information processing apparatus 320. As a consequence, the content is not reproduced.

When the drive 350 determines in step S201 that the physical mark 101 has been recorded on the disc 100, in step S202, the drive 350 sequentially provides the MKB 103 . . . the encoded content 107 recorded on the disc 100 to the information processing apparatus 320.

Next, in step S211, the information processing apparatus 320 performs a signature verification process by using the medium ID 102 and the token 104 read from the disc 100 via the drive 350. As described earlier, the token 104 is data generated by the content distribution server 250, which contains the signature for the medium ID 102 recorded on the disc 100.

The information processing apparatus 320 performs a signature verification process for the token 104 read from the disc 100. Data processing using the public key of the content providing server 250 is performed for the signature contained in the token 104. The comparison of the processing result with the constituent data of the medium ID 102 recorded on the disc 100, the hash value thereof or the like is performed. If they match, the signature verification is determined to hold true.

When they do not match, it is determined that the signature verification does not hold true, that is, the token 104 recorded on the disc 100 is determined to be invalid, and the content providing server 250 is determined to be not a legal apparatus. In this case, the subsequent processing is cancelled. That is, the content use (reproduction) process is cancelled.

Only when the drive 350 confirms that the physical mark 101 has been recorded on the disc 100 in step S211 and when the signature verification process holds true in step S201, the process proceeds to the next process, that is, the decoding and reproduction sequence (S221 to S224) of the encoded content 107 recorded on the disc 100.

The processing of steps S221 to S224 is the same as the processing of steps S111 to S114 described with reference to FIG. 3 in the first embodiment and accordingly, the description thereof is omitted. The switch 321 shown in the figure is described for illustration similarly to the first embodiment described above, and is not necessary to physically exist.

That is, the switch 321 is shown for illustration indicating that content can be decoded and reproduced only when the signature verification process of step S211 holds true. The position of the switch 321, that is, the stop position of the process, is shown before step S224 in FIG. 4. Alternatively, the position of the switch 321 may be any position of the decoding and reproduction sequence of content, such as, for example, before the MKB process of step S221.

Also, in the present embodiment, the use permission conditions of the encoded content recorded on the disc 100 are set as follows:

(1) Confirmation that the physical mark 101 has been recorded on the disc 100, and
(2) Confirmation of the authenticity of the token 104 (signature for the medium ID 102) recorded on the disc 100.

These two confirmations are conditions for permitting the use of the encoded content recorded on the disc 100.

If either of the conditions is not satisfied, the use of the content is not permitted.

Also, in the present second embodiment, similarly to the first embodiment, by confirming that the physical mark 101 has been recorded on the disc 100, the disc authenticity that the disc 100 has been produced at a legal factory is confirmed. Furthermore, as a result of the signature verification of the token 104, it is confirmed that the content provided by the legal content distribution server has been recorded on the disc. The fact that the authenticities of the content providing source and the disc supply source have been confirmed in the manner described above is used as the permission condition for content use. Such a content use control configuration makes it possible to prevent the use of an illegal disc or the use of the provided content of an illegal content providing server. Thus, it becomes possible to realize stringent content use control.

### 4. Data Recording and Reproduction Processing Example 3

### Third Embodiment

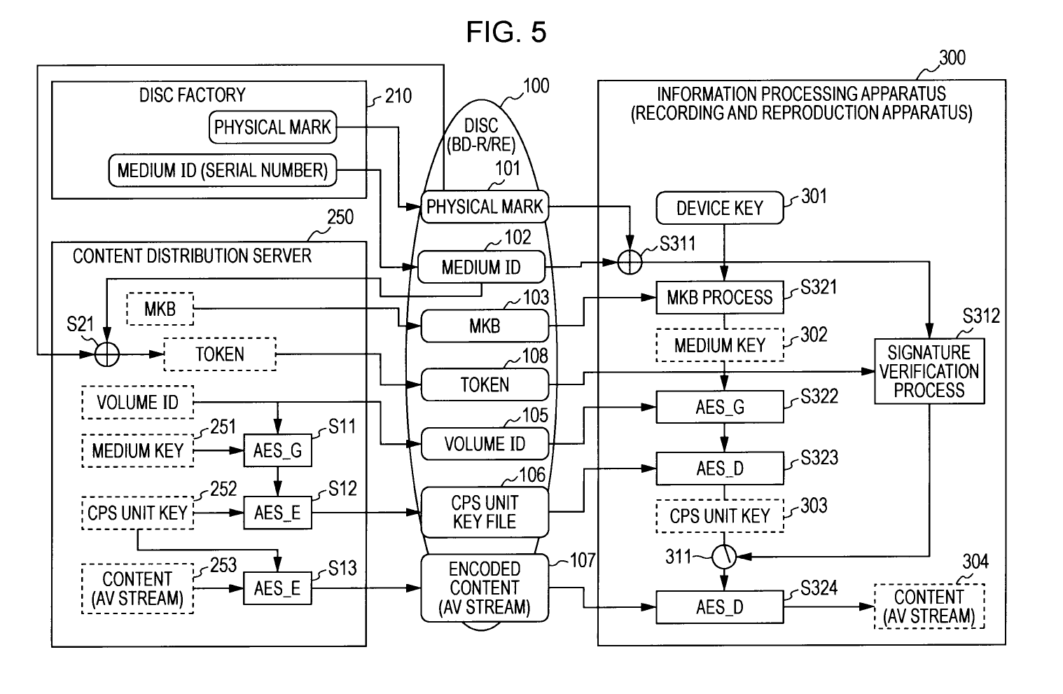

Next, a description will be given, with reference to FIG. 5, of a third embodiment of a process for recording content on a disc and a process for reproducing content from a disc in accordance with the present invention.

The third embodiment, similarly to the first embodiment, has a configuration in which the information processing apparatus 300 is integrated with a drive. FIG. 5 shows a disc factory 210 that manufactures the disc 100, a content providing server 250 that provides recording data containing content to be recorded on the disc 100, and an information processing apparatus (recording reproduction apparatus) 300 that performs a content recording process on the disc 100, that reads data recorded on the disc 100, and that reproduces content.

As described earlier, the disc factory 210 performs a process for recording the physical mark 101 and the medium ID (serial number) 102 on the disc 100. The user purchases the disc 100 on which the physical mark 101 and the medium ID (serial number) 102 have been recorded.

The user loads the disc 100 into the information processing apparatus 300, and performs communication with the content providing server 250 that provides content, and records the content selected by the user. The content providing server 250 and the information processing apparatus 300 perform communication via a network. Recording data for the disc 100 is provided from the content providing server 250 to the information processing apparatus 300, and the information processing apparatus 300 performs data recording on the disc 100. The content providing server 250 and the information processing apparatus 300 perform communication via a network. Recording data for the disc 100 is provided from the content providing server 250 to the information processing apparatus 300, and the information processing apparatus 300 performs data recording on the disc 100.

When performing the content recording process, the content providing server 250 provides the data of the MKB 103, the token 108, the volume ID 105, the CPS unit key file 106, and the encoded content 107 to the information processing apparatus 320. The information processing apparatus 320 records, on the disc 100, the data received from the content providing server 250 via the drive 350.

The difference in the data recording process from the first embodiment described with reference to FIG. 3 is the structure of the token 108.

In the first embodiment described earlier, the token 104 recorded on the disc 100 has signature data for the medium ID 102. That is, the information processing apparatus 300 transmits only the medium ID 102 recorded on the disc 100 to the content providing server 250. The content providing server 250 generates the token 104 containing a signature based on the medium ID and provides the signature as recording data for the disc 100.

In contrast, in the present embodiment, the information processing apparatus 300 transmits two items of data of the physical mark 101 and the medium ID 102 that are recorded on the disc 100 to the content providing server 250. When the content providing server 250 receives the two items of data of the physical mark 101 and the medium ID 102, in step S21 shown in FIG. 5, the content providing server 250 performs the exclusive OR operation of the two items of data of the physical mark 101 and the medium ID 102.

By using the result of the exclusive OR operation of the two data, a signature is generated. That is, a signature is generated for the exclusive OR operation result of the two data of the physical mark 101 and the medium ID 102 or on the basis of the data generated from the result, and a token containing this signature data is generated. The content providing server 250 transmits the token generated in the manner described above to the information processing apparatus 300. The information processing apparatus 300 records the token received from the content providing server 250 on the disc 100. The result is a token 108 recorded on the disc 100 of FIG. 5.

That is, in the present embodiment, the token 108 recorded on the disc 100 is configured to contain a signature generated on the basis of not only the medium ID, but also the constituent data of the physical mark.

The other data recorded on the disc 100, that is, the MKB 103, the volume ID 105, the CPS unit key file 106, and the encoded content 107, are recorded on the disc 100 by the same processing as the first embodiment described above.

A decoding process and a reproduction process for the encoded content 107 recorded on the disc 100 will be described. The information processing apparatus 300 has a device key 301 in the memory. The device key 301 is key data used to obtain a medium key from the MKB 103.

Initially, in step S311, the information processing apparatus 300 reads the physical mark 101 and the medium ID 102 that are recorded on the disc 100, and performs an exclusive OR operation of these two data.

Next, in step S312, the token 108 recorded on the disc 100 is read, and a signature verification process is performed. As described earlier, the token 108 is data containing a signature for the exclusive OR result of the physical mark 101 and the medium ID 102 that are recorded on the disc 100. the token 108 is a signature generated by the content providing server 250.

In step S312, the information processing apparatus 300 performs signature verification by using the public key of the content providing server 250. Data processing using the public key of the content providing server 250 is performed on the signature contained in the token 108, and the processing result thereof is compared with the data generated in step S311.

In step S311, the physical mark 101 and the medium ID 102 that are recorded on the disc 100 are read, and an exclusive OR result of these two data is calculated. This calculation result is compared with the data processing result in which the public key has been applied to the signature contained in the token 108.

When they match, the signature verification is determined to hold true. As a result of the signature verification holding true, the authenticity of the token 108 is confirmed. This corresponds to the confirmation that the supply source of the encoded content 107, that is, the content providing server 250, is a legal apparatus and that the disc factory that is the disc manufacturing source is authentic. After this confirmation is made, the decoding of the content is permitted.

In a case where the signature verification does not hold true, the token 108 is determined to be invalid, and the content providing server or the disc manufacturing factory is determined to be illegal. In this case, the subsequent processing is cancelled. That is, the content use (reproduction) process is cancelled.

Only in the case that the signature verification process in step S312 holds true, the process proceeds to the next process, that is, a decoding and reproduction sequence (S321 to S324) of the encoded content 107 recorded on the disc 100.

The processing of steps S321 to S324 is the same processing of steps S111 to S114 described with reference to FIG. 3, and accordingly, the description thereof is omitted. A switch 311 shown in the figure, similarly to the first embodiment described above, is described for illustration, and is not necessary to physically exist.

That is, the switch 311 is shown to describe that content can be decoded or reproduced only in the case that the signature verification process of step S312 holds true. The position of the switch 311, that is, the process stop position, is shown before step S324 in FIG. 5. Alternatively, the position of the switch 311 may be any position of the content decoding and reproduction sequence, such as, for example, before the MKB process of step S321.

In the present embodiment, the use permission condition of the encoded content recorded on the disc 100 is:

Confirmation of the authenticity of (1) the token 108 (signature for the computation operation result based on the physical mark 101 and the medium ID 102) recorded on the disc 100.

This signature verification process is a process including confirmation that the physical mark 101 and the medium ID have been recorded on the disc 100, and confirmation that a token for which a signature is generated by a legal content distribution server has been recorded.

That is, as a result of signature verification of the token 108, it is confirmed that the disc 100 is a disc produced by a legal factory having a licensed physical mark recording device and that content provided by the legal content distribution server has been recorded on the disc.

It is set as a permission condition for content use that the authenticities of the disc supply source and the content providing source has been confirmed in the manner described above.

With such a content use control configuration, it is possible to prevent the use of an illegal disc or the use of provided content of an illegal content providing server. Thus, it is possible to realize stringent content use control.

In the processing example described with reference to FIG. 5, an exclusive OR operation result of the physical mark 101 and the medium ID recorded on the disc 100 is used as information for generating signature data to be contained in the token 108. Not limited to an exclusive OR operation, other operations may be used. That is, the signature may be generated on the basis of a calculated value obtained by a computation operation in which the physical mark 101 and the medium ID are used as input values.

### 5. Data Recording and Reproduction Processing Example 4

### Fourth Embodiment

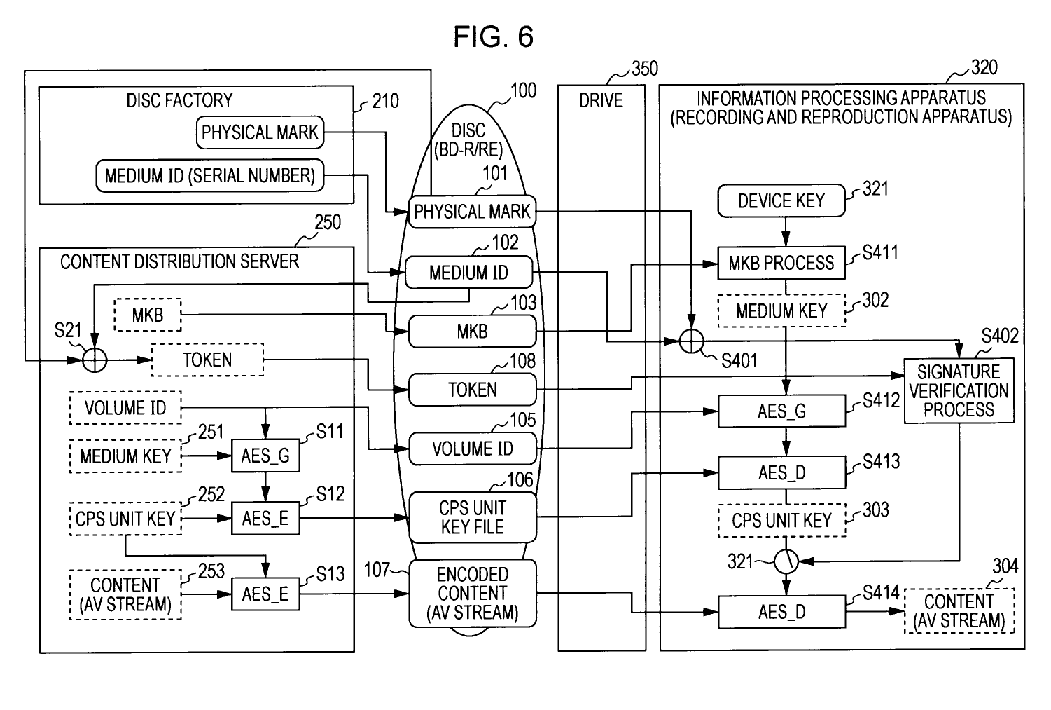

Next, a description will be given, with reference to FIG. 6, of a fourth embodiment of a process for recording content on a disc and a process for reproducing content from a disc.

FIG. 6 shows a disc factory 210 that manufactures a disc 100, a content providing server 250 that provides data containing content to be recorded on the disc 100, a drive 350 that performs a process for recording content on the disc 100 and that reads data from the disc 100, and an information processing apparatus (recording reproduction apparatus) 320 that performs data recording and reproduction by using the disc 100 via the drive 350.

The present embodiment, similarly to the configuration described earlier with reference to FIG. 4, is configured in such a manner that the drive 350 and the information processing apparatus 320 are separate devices. Furthermore, the token 108 recorded on the disc 100 is configured to include a signature for the computation operation result based on the physical mark 101 and the medium ID 102 in the same manner as in the third embodiment described with reference to FIG. 5.

A data recording process for the disc 100 is nearly the same process of the third embodiment described earlier with reference to FIG. 5. When performing the content recording process, the content providing server 250 provides the data of the MKB 103, the token 108, the volume ID 105, the CPS unit key file 106, and the encoded content 107 to the information processing apparatus 320. The information processing apparatus 320 records, via the drive 350, these data received from the content providing server 250 on the disc 100.

The token 108 is configured to include a signature generated on the basis of not only the medium ID but also the constituent data of the physical mark. When performing a content recording process on the disc 100, the information processing apparatus 320 reads the physical mark 101 and the medium ID 102 recorded on the disc 100 via the drive 350. The information processing apparatus 320 transmits these two data to the content providing server 250. When the content providing server 250 receives the two data of the physical mark 101 and the medium ID 102, in step S21 shown in FIG. 6, the content providing server 250 performs an exclusive OR operation of the two data of the physical mark 101 and the medium ID 102.

A signature is generated by using a result of the exclusive OR operation of these two data. That is, a signature is generated on the basis of an exclusive OR result of the two data of the physical mark 101 and the medium ID 102 or for data generated from this result, and a token containing this signature data is generated. The content providing server 250 transmits the token generated in the manner described above to the information processing apparatus 320. The information processing apparatus 320 records, on the disc 100, the token received from the content providing server 250 via the drive 350. This result is the token 108 recorded on the disc 100 of FIG. 6.

Processes for decoding and reproducing the encoded content 107 recorded on the disc 100 will be described. The information processing apparatus 320 has a device key 321 in the memory. The device key 321 is key data used to obtain a medium key from the MKB 103.

First, in step S401, the information processing apparatus 320 reads the physical mark 101 and the medium ID 102 recorded on the disc 100 via the drive 350, and performs an exclusive OR operation of these two data.

Next, in step S402, the token 108 recorded on the disc 100 is read via the drive 350, and a signature verification process is performed. As described earlier, the token 108 is data containing a signature for the exclusive OR result of the physical mark 101 and the medium ID 102 recorded on the disc 100. The token 108 is a signature generated by the content providing server 250.

In step S402, the information processing apparatus 320 performs signature verification by using the public key of the content providing server 250. Data processing using the public key of the content providing server 250 is performed on the signature contained in the token 108, and the processing result thereof is compared with the data generated in step S401.

In step S401, an exclusive OR result of the physical mark 101 and the medium ID 102 recorded on the disc 100 is calculated. This calculation result is compared with a data processing result in which the public key is used for the signature contained in the token 108.

When they match, the signature verification is determined to hold true. As a result of the signature verification holding true, the authenticity of the token 108 is confirmed. This corresponds to that the supply source of the encoded content 107, that is, the content providing server 250, is confirmed to be a legal device and that the authenticity of the disc factory that is a disc manufacturing source is confirmed. After this confirmation is made, the decoding of the content is permitted.

In a case where the signature verification does not hold true, the token 108 is determined to be invalid, and the content providing server or the disc manufacturing factory is determined to be invalid. In this case, the subsequent processing is cancelled. That is, the use (reproduction) process of the content is cancelled.

Only in the case that the signature verification process in step S402 holds true, the process proceeds to the next process, that is, a decoding and reproduction sequence (S411 to S414) of the encoded content 107 recorded on the disc 100.

The processing of steps S411 to S414 is the same processing of steps S111 to S114 described with reference to FIG. 3 and accordingly, a description thereof is omitted. A switch 321 shown in the figure, similarly to the embodiments described earlier, is described for illustration, and is not necessary to physically exist. The position thereof may be any position of before steps S411 to S414 as long as the position is before step S414.

Similarly to the third embodiment described above with reference to FIG. 5, in the present embodiment, the condition in which the use of encoded content recorded on the disc 100 is permitted is the following:

(1) the authenticity of the token 108 (signature for the computation operation result based on the physical mark 101 and the medium ID 102) recorded on the disc 100 is confirmed.

This signature verification process is a process including a confirmation that the physical mark 101 and the medium ID have been recorded on the disc 100 and a confirmation that a token for which signature has been generated by a legal content distribution server have been recorded.

That is, it is confirmed by the signature verification of the token 108 that the disc 100 is a disc produced at a legal factory having a licensed physical mark recording device and that content provided by a legal content distribution server has been recorded on the disc.

It is the condition of permitting content use that the authenticities of the disc supply source and the content providing source have been confirmed as described above.

With such a content use control configuration, it is possible to prevent the use of an illegal disc or the use of content provided by an illegal content providing server. Thus, it is possible to realize stringent content use control.

In the processing example described with reference to FIG. 6, an exclusive OR operation result of the physical mark 101 and the medium ID recorded on the disc 100 is used as information for generating signature data to be contained in the token 108. Not limited to an exclusive OR operation, other operations may be used. That is, a signature may be configured to be generated on the basis of calculated values obtained by performing a computation operation in which the physical mark 101 and the medium ID are used as input values.

### 6. Specific Example of Physical Mark

As described above with reference to FIG. 2, a physical mark and a medium ID (serial number) are recorded on a disc. The medium ID (serial number) is recorded, for example, in a burst cutting area (BCA) on a disc by a burst cutting process. This recording method has been disclosed.

On the other hand, the method of recording a physical mark is not disclosed. More specifically, the physical mark is recorded only in a physical mark recording device provided by a content management center, such as Advanced Access Content System (AACS), to a licensed disc factory.

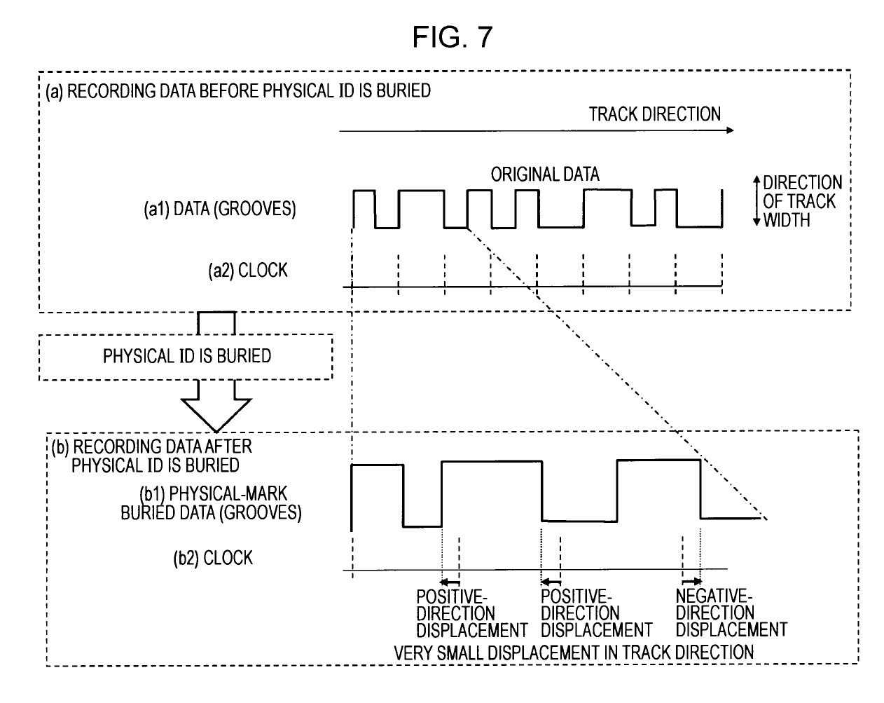

With reference to FIG. 7, an example of the recording structure of a physical mark will be described below. An example of the recording of a physical mark (to be described later) illustrates an example of the structure that can be used as a physical mark recording form. An example of the recording structure of a physical mark, which can be used in the present invention, is not limited to a physical mark to be described below.

FIG. 7 shows an example of the recording structure of a physical mark for a recordable disc. On a recordable disc, as shown in part (a) of FIG. 7, grooves displaced in the direction of the track width, so-called wobbles, are formed in a prerecorded data zone formed in the inner peripheral side of a disc at the manufacturing stage thereof. In this prerecorded data zone, information at the time of shipment of the disc, and the like are recorded. the grooves are, for example, read-only grooves, which are recorded in a lead-in area of a recordable disc, such as that disclosed in Japanese Unexamined Patent Application Publication No. 2003-12332.

Part (a1) of FIG. 7 is assumed to show the recording data of a prerecorded data zone. The recording data of the prerecorded data zone can be read by using a predetermined clock signal as a synchronization signal. the recording data can be read in accordance with a clock signal shown in part (a2) of FIG. 7.

The physical mark can be buried in such a manner as to be superposed on the recording data of the prerecorded data zone. For example, part (b1) of FIG. 7 shows a result in which a physical mark is buried in such a manner as to be superposed on the recording data of the prerecorded data zone.

In the physical mark buried data shown in part (b1) of FIG. 7, the displacement position of the original data shown in part (a1) of FIG. 7 is offset from the clock timing. The offset direction is either a forward direction (positive direction) or a backward direction (negative direction).

This offset direction is determined in accordance with information on bits forming the physical mark to be recorded. If the bit forming the physical mark is [1], an offset in the positive direction is generated, and if it is [0], an offset in the negative direction is generated, or a process reverse to that is performed. However, since this offset is a very small displacement, it can occur that reproduction is not possible if noise is carried. Thus, it is desirable that an area in which physical marks are superposed on the basis of similar displacements are formed in the direction of a plurality of tracks. When performing a physical mark reproduction process, physical marks can be read by the following setting in which position displacements are detected in areas where physical marks are superposed, and the logic value is set at 1 in a case where positive direction displacements, the number of which is a threshold value or more, are detected, and the logic value is set at 0 in a case where negative direction displacements, the number of which is a threshold value or more, are detected. That is, when a mother disc used for manufacturing a stamper is to be manufactured, in wobbles in which information at the time of shipment is recorded within the lead-in area, physical marks are recorded with the very small displacements unique to the mother disc. Therefore, the unique mark is also transferred to the stamper that is produced by using the mother disc. Furthermore, similar physical marks are transferred to recordable discs that are mass-produced on the basis of the stamper.

In addition to the structure of the physical mark shown in FIG. 7, various recording processes are possible. However, this recording method is set not to be disclosed. That is, the physical marks are data that can be recorded by only the physical mark recording device provided to only a specific, licensed disc factory by using a nondisclosed recording method.

### 7. Example of Configuration of Information Processing Apparatus

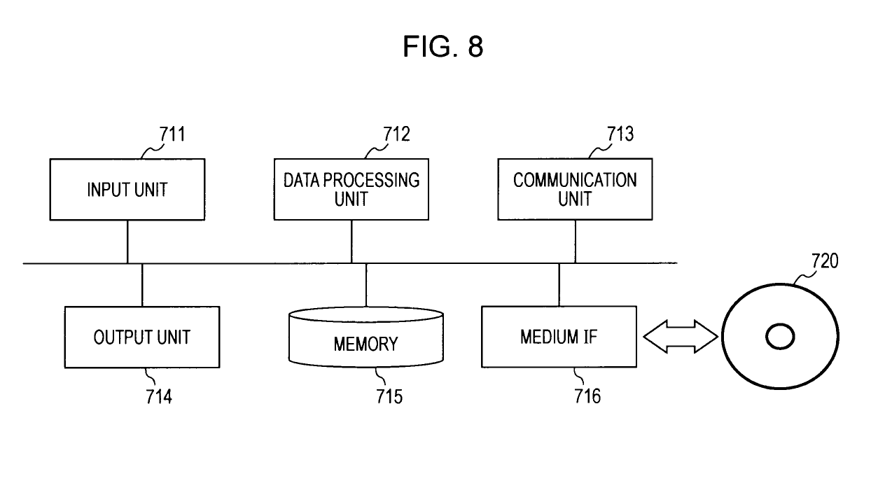

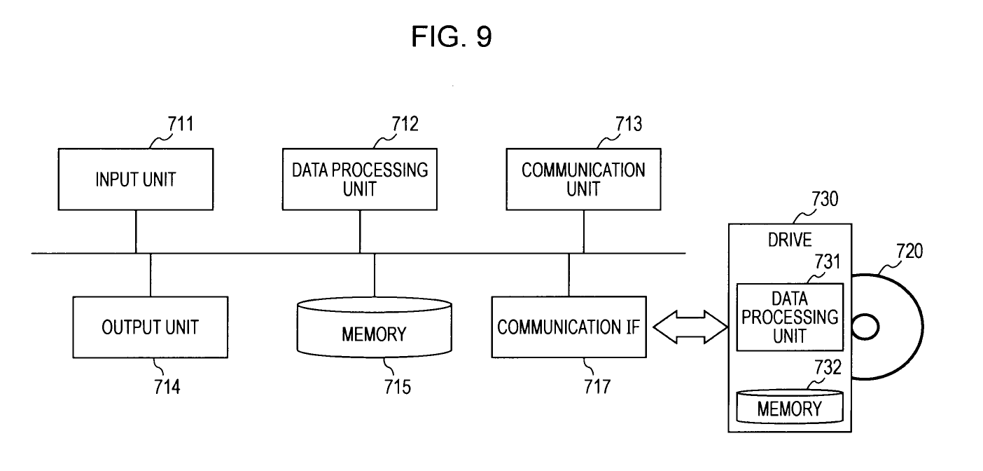

With reference to FIGS. 8 and 9, a description will be given of the functions and configuration of an information processing apparatus that performs processing that corresponds to the above-described embodiments. FIG. 8 shows an example of the configuration of an information processing apparatus.

As shown in FIG. 8, the information processing apparatus includes an input unit 711, a data processing unit 712, a communication unit 713, an output unit 714, a memory 715, and a medium interface 716. The information processing apparatus shown in FIG. 8 performs data recording on a medium 720 formed by, for example, a DVD, a Blu-ray Disc (registered trademark), or the like, via the medium interface 716, or data reproduction from the medium 720.

The input unit 711 receives user operation information. The communication unit 713, more specifically, performs communication with a content providing server.

In the memory 715, a device key serving as an device unique key, data, programs, and the like, which are received via the communication unit 713, are stored. The data processing unit 712 performs a content recording and reproduction process and also performs control of a data transmission and reception process via the communication unit 713. The data processing unit 712 performs, for example, content recording and reproduction control processes in accordance with the processing of the above-described first to fourth embodiments.

FIG. 9 shows an example of the configuration of an information processing apparatus from which a drive device 730 is separated. The drive 730 includes a data processing unit 731 and a memory 732. Data communication with the drive 730 is performed via a communication IF 717. The data processing unit 731 within the drive 730 performs processing in accordance with a program stored in the memory 732. More specifically, examples thereof include a physical mark verification process, and an input/output control process for data read from a disc, which are described with reference to FIG. 4. The remaining configuration is the same as the configuration described with reference to FIG. 8.

The present invention has been described above in detail while referring to specific embodiments. However, it is obvious for a person skilled in the art to make modifications and substitutions of the embodiments within the spirit and scope of the present invention. That is, the present invention has been disclosed as exemplary embodiments, and should not be construed as being limited. In order to determine the gist of the present invention, the claims should be taken into consideration.

The series of processes described in the specification can be executed by hardware, software, or a combination of both. In the case where the series of processes is to be performed by software, a program recording the processing sequence may be installed in a memory in a computer embedded in dedicated hardware and executed. Alternatively, the program may be installed on a general-purpose computer capable of performing various processes and executed. For example, the program may be pre-recorded on a recording medium. Besides installing the program from the recording medium to a computer, the program can be received via a network, such as a local area network (LAN) or the Internet, and can be installed into a recording medium such as a hard disk contained therein.

The various processes described in the specification are not necessarily performed sequentially in the orders described, and may be performed in parallel or individually in accordance with the processing performance or necessity of an apparatus that performs the processes. In this specification, the system designates a logical assembly of a plurality of devices, and it does not matter whether the devices are disposed in the same housing.

The present application contains subject matter related to that disclosed in Japanese Priority Patent Application JP 2009-078663 filed in the Japan Patent Office on Mar. 27, 2009, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus comprising:
a data processing unit configured to perform data processing on data read from a data recordable disc,
wherein the data processing unit performs
a physical mark verification process for verifying whether or not a physical mark that is identification data unique to each of mother discs used when the data recordable disc was manufactured has been recorded on the data recordable disc, and
a signature verification process for obtaining, from the data recordable disc, a token containing an electronic signature generated on the basis of a medium ID that is an identifier unique to each data recordable disc by a content providing server that provided the recorded content of the data recordable disc and for performing signature verification, and
the data processing unit reproduces recorded content of the data recordable disc under a condition in which the recording of a physical mark in the physical mark verification process is confirmed and the signature verification in the signature verification process holds true.

2. The information processing apparatus according to claim 1,
wherein the physical mark and the medium ID are data recorded on the data recordable disc at a disc factory, and
wherein the token is a token that contains the electronic signature generated on the basis of the medium ID by the content providing server that provided the content when performing a content recording process on the data recordable disc.

3. An information process system comprising:
a drive configured to perform data reading from a data recordable disc; and
an information processing apparatus including a data processing unit that obtains data read from the data recordable disc via the drive and that performs data processing,
wherein the drive
performs a physical mark verification process for verifying whether or not a physical mark that is identification data unique to each of mother discs used when the data recordable disc was manufactured has been recorded on the data recordable disc, and
outputs the recorded data of the data recordable disc to the information processing apparatus under a condition in which the recording of the physical mark has been confirmed in the physical mark verification process, and
wherein the data processing unit
performs a signature verification process for obtaining, from the data recordable disc, a token containing an electronic signature generated on the basis of the medium ID that is an identifier unique to each data recordable disc by a content providing server that provided the recorded content of the data recordable disc, and for performing signature verification, and
reproduces the recorded content of the data recordable disc under a condition in which the signature verification in the signature verification process holds true.

4. The information process system according to claim 3,
wherein the physical mark and the medium ID are data recorded on a data recordable disc at a disc factory, and
wherein the token is a token that contains the electronic signature generated on the basis of the medium ID by the content providing server that provided the content when performing a content recording process on the data recordable disc.

5. An information processing apparatus comprising:
a data processing unit configured to perform data processing on data read from a data recordable disc,
wherein the data processing unit
obtains, from the data recordable disc, a token containing an electronic signature generated by a content providing server that provided the recorded content of the data recordable disc, and performs a signature verification process, and
reproduces the recorded content of the data recordable disc under a condition in which the signature verification in the signature verification process holds true, and
wherein the token is a token containing an electronic signature generated on the basis of a computation operation result of a physical mark that is identification data unique to each of mother discs used when the data recordable disc was manufactured, and a medium ID that is an identifier unique to each data recordable disc, the physical mark and the medium ID being recorded on the data recordable disc.

6. The information processing apparatus according to claim 5,
wherein the token is a token containing an electronic signature generated on the basis of an exclusive OR operation result of the physical mark and the medium ID, and
wherein the data processing unit performs an exclusive OR operation of the physical mark and the medium ID that are recorded on the data recordable disc, and performs a comparison process with the exclusive OR operation result when performing a process for verifying the signature contained in the token.

7. The information processing apparatus according to any one of claims 5 and 6,
wherein the physical mark and the medium ID are data recorded on a data recordable disc at a disc factory, and
wherein the token is a token that contains the electronic signature generated on the basis of the medium ID by the content providing server that provided the content when performing a content recording process on the data recordable disc.

8. An information processing apparatus comprising:
a data processing unit configured to perform data processing on data read from a data recordable disc,
wherein the data processing unit
obtains, from the data recordable disc, a physical mark that is identification data unique to each of mother discs used when the data recordable disc was manufactured, and a medium ID that is an identifier unique to each data recordable disc, and transmits the physical mark and the medium ID to a content providing server, and
receives, from the content providing server, a token containing an electronic signature generated on the basis of the computation operation result of the physical mark and the medium ID, and content, and records the token and the content on the data recordable disc.

9. The information processing apparatus according to claim 8, wherein the token is a token containing an electronic signature generated on the basis of the exclusive OR operation result of the physical mark and the medium ID.

10. The information processing apparatus according to any one of claims 8 and 9,
wherein the physical mark and the medium ID are data recorded on a data recordable disc at a disc factory, and
wherein the token is a token that contains the electronic signature generated on the basis of the medium ID by the content providing server that provided the content when performing a content recording process on the data recordable disc.

11. An information processing method for performing data processing on data read from a data recordable disc in an information processing apparatus, the information processing method comprising the steps of:
verifying, by using a data processing unit, whether or not a physical mark that is identification data unique to each of mother discs used when the data recordable disc was manufactured has been recorded on the data recordable disc;
obtaining, by using a data processing unit, from the data recordable disc, a token containing an electronic signature generated on the basis of a medium ID that is an identifier unique to each data recordable disc by a content providing server that provided the recorded content of the data recordable disc, and performing signature verification; and
reproducing, by using a data processing unit, recorded content of the data recordable disc under a condition in which the recording of the physical mark in the physical mark verification process has been confirmed and the signature verification in the signature verification process holds true.

12. An information processing method for performing data processing on data read from a data recordable disc in an information processing apparatus, the information processing method comprising the steps of:
performing, by using a data processing unit, a computation process of a physical mark that is identification data unique to each of mother discs used when the data recordable disc was manufactured, and a medium ID that is an identifier unique to each data recordable disc;
obtaining, by using a data processing unit, from the data recordable disc, a token containing an electronic signature generated by a content providing server that provided the recorded content of the data recordable disc, and performing a signature verification process including a process for comparing data generated on the basis of the electronic signature with the resulting data of the computation operation process; and
reproducing recorded content of the data recordable disc under a condition in which the signature verification in the signature verification process holds true.

13. An information processing method for performing data processing on data read from a data recordable disc in an information processing apparatus, the information processing method comprising the steps of:
obtaining, by using a data processing unit, from the data recordable disc, a physical mark that is identification data unique to each of mother discs used when the data recordable disc was manufactured, and a medium ID that is an identifier unique to each data recordable disc, and transmitting the physical mark and the medium ID to a content providing server; and
receiving, by using the data processing unit, from the content providing server, a token containing an electronic signature generated on the basis of the computation operation result of the physical mark and the medium ID, and content, and recording the medium ID and the content on the data recordable disc.

14. A non-transitory recording medium including a program for processing data read from a recordable medium, the program comprising the steps of:
causing a data processing unit to verify whether or not a physical mark that is identification data unique to each of mother discs used when the data recordable disc was manufactured has been recorded on the data recordable disc;
causing the data processing unit to obtain, from the data recordable disc, a token containing an electronic signature generated on the basis of a medium ID that is an identifier unique to each data recordable disc by a content providing server that provided the recorded content of the data recordable disc, and to perform signature verification; and
causing the data processing unit to reproduce recorded content of the data recordable disc under a condition in which the recording of the physical mark in the physical mark verification process has been confirmed and the signature verification in the signature verification process holds true.

15. A non-transitory recording medium including a program for processing data read from a recordable medium, the program comprising the steps of:
causing a data processing unit to perform a computation process of a physical mark that is identification data unique to each of mother discs used when a data recordable disc was manufactured, and a medium ID that is an identifier unique to each data recordable disc;
causing the data processing unit to obtain, from the data recordable disc, a token containing an electronic signature generated by a content providing server that provided the recorded content of the data recordable disc, and to perform a signature verification process including a process for comparing data generated on the basis of the electronic signature with the resulting data of the computation operation process; and
reproducing recorded content of the data recordable disc under a condition in which the signature verification in the signature verification process holds true.

16. A non-transitory recording medium including a program for processing data read from a recordable medium, the program comprising the steps of:
causing a data processing unit to obtain, from the data recordable disc, a physical mark that is identification data unique to each of mother discs used when a data recordable disc was manufactured, and a medium ID that is an identifier unique to each data recordable disc, and transmitting the physical mark and the medium ID to a content providing server; and
causing the data processing unit to receive, from the content providing server, a token containing an electronic signature generated on the basis of the computation operation result of the physical mark and the medium ID, and content, and to record the medium ID and the content on the data recordable disc.
